(19) United States
(12) Patent Application Publication
(10) Pub. No.: US 2026/0039330 A1
(43) Pub. Date: Feb. 5, 2026

(54) Vehicle communication device with passive selection circuit

(71) Applicant: Continental Automotive Technologies GmbH, Hannover (DE)

(72) Inventors: Guilherme Germano BUCHMEIER, Toulouse (FR); Mohamed CHEIKH, L'Union (FR); Amaia FORTES MONTILLA, Muret (FR)

(73) Assignee: Continental Automotive Technologies GmbH, Hannover (DE)

(21) Appl. No.: 19/285,070

(22) Filed: Jul. 30, 2025

(30) Foreign Application Priority Data
Aug. 2, 2024 (FR) FR2408578

(51) Int. Cl. H04B 5/70; H04B 1/3822

(52) U.S. Cl. CPC H04B 5/70; H04B 1/3822

(57) ABSTRACT

A communication device for a vehicle, including a single communication antenna, a matching circuit configured to match the impedance of the communication antenna, a high-frequency processing module connected to the matching circuit and configured to process high-frequency signals received by the antenna, and a passive selection circuit connected to the matching circuit and configured to communicate with a near-field communication module which receives signals via the antenna, to operate in an open circuit when the strength of the signals received by the antenna is below a predetermined strength threshold, and to transfer the signals received by the antenna to the near-field communication module via the matching circuit when the strength of said signals is above the predetermined strength threshold.

### CROSS REFERENCE TO RELATED APPLICATIONS

This application claims priority to French Application No. 2408578, filed Aug. 2, 2024, the contents of such application being incorporated by reference herein.

### FIELD OF THE INVENTION

The present invention relates to the field of motor vehicles and more particularly to a device for communicating high-frequency and near-field signals.

### BACKGROUND OF THE INVENTION

In the field of radiofrequency communications, in particular for motor vehicles, several types of radiofrequency waves are used for different applications.

One determining criterion for the type of radiofrequency emission used is the distance between the emitter and the receiver; another is the necessary quality of the reception of the signal.

For short-distance applications, of the order of a few meters, and where the quality of the information transmitted by the signal is not essential, so-called “high-frequency” radiofrequencies are generally used. The high-frequency (HF) range comprises emission frequencies of between 3 and 30 megahertz (MHz).

For very short-distance applications, below 10 centimeters, and where the quality of the information transmitted is vital, NFC (Near-Field Communication) technology is often used. The operating frequency of NFC is 13.56 megahertz.

These two types of radiofrequency signals involve the use, in the receivers, of different types of electronic circuits for each.

In some applications, such as in a motor vehicle, it may be advantageous to have a receiver device which combines both types of radiofrequency signals. For a portable access device which makes it possible to unlock a vehicle and to activate functions of the vehicle, it is thus advantageous to be able to receive high-frequency signals or near-field signals between the user and the vehicle.

Itis then necessary to have circuits necessary for both types of radiofrequency emissions in the same device.

A first solution is to have both circuits each with a corresponding antenna in the device. This solution is not advantageous because the space in devices of key or electronic fob type for a car is limited and the presence of two circuits so close together may create cross-interference between the two.

Another solution is to have a single circuit for both types of radiofrequency emissions. This solution solves the problem of space and cross-interference but the single circuit inevitably degrades the quality of the signal transmitted by both types of radiofrequency emissions.

Finally, one solution consists in having a common part for both types of radiofrequency emissions and a smart circuit capable of detecting the type of radiofrequency emission and of activating the corresponding components. This solution also solves the problem of space and cross-interference but the smart circuit needs a permanent power supply, this considerably reducing the life of devices such as keys or electronic fobs for a vehicle.

A simple, reliable and efficient solution which makes it possible to remedy these drawbacks at least in part would therefore be advantageous.

### SUMMARY OF THE INVENTION

To this end, one aspect of the invention is firstly a communication device for a motor vehicle, said device comprising a single communication antenna, a matching circuit configured to match the impedance of said antenna, a high-frequency processing module connected to said matching circuit and configured to process high-frequency signals received by the antenna, and a passive selection circuit connected to the matching circuit and configured to communicate with a near-field communication module so that said near-field communication module receives signals via the antenna, to operate in an open circuit when the strength of the signals received by the antenna is below a predetermined strength threshold, and to transfer the signals received by the antenna to the near-field communication module via the matching circuit when the strength of said signals is above the predetermined strength threshold.

The device according to an aspect of the invention may thus receive radiofrequency signals of high-frequency type and of near-field type via a single communication antenna, and adapt the signals received according to their type in order to redirect them to the appropriate processing module. The passive selection circuit acts as a switch which does not require its own power supply because it closes when the antenna receives near-field signals which generate a sufficient voltage in the circuits of the device and remains open in the rest of the cases. The circuit according to an aspect of the invention is thus self-sufficient in terms of energy. This simple circuit is therefore inexpensive and has a limited space requirement in the device since it does not require any additional components for power supply or active management, such as a microcontroller.

Advantageously, the passive selection circuit comprises a transistor, said transistor comprising a collector, a base and an emitter, said collector being connected to the output of the matching circuit, said emitter being configured to communicate with the near-field communication module, said base being connected to said collector. The operation of the transistor makes it a switch which is open as long as the voltage at the base is not sufficient. When the device receives a high-frequency signal, the voltage generated in the circuit is too low for the transistor and the passive selection circuit is then open. In contrast, when the device receives a near-field signal, the voltage generated in the circuit is then sufficient for the transistor and the passive selection circuit is then closed, allowing the signal to be sent to the near-field communication module.

Any type of transistor may be used in the selection circuit according to an aspect of the invention, for example GaN, FET, MOSFET transistors, the connections of which do not have the same name.

Again advantageously, the passive selection circuit comprises a transistor, a diode, and an electrical capacitor, said diode being connected by its input terminal to the output of the matching circuit, said transistor comprising a collector, a base and an emitter, said collector being connected to the output of the matching circuit, said emitter being connected to said capacitor and being configured to communicate with the near-field communication module, said base being connected to the midpoint connecting the output terminal of said diode to said capacitor.

Preferably, the matching circuit comprises a plurality of at least three electrical capacitors, including a first capacitor connected in series with the communication antenna, the second capacitor and the third capacitor being connected to the first electrical capacitor, the second capacitor being connected to the passive selection circuit, the third capacitor being connected to the other pole of the antenna, and the high-frequency processing module being connected to the junction between the three capacitors. These various capacitors make it possible to match the impedance of the matching circuit according to the type of signal received. The second capacitor is only flown through by an electric current when the passive selection circuit is closed, thus modifying the impedance of the matching circuit between the reception of a high-frequency signal and a near-field signal.

In a first embodiment, the device according to the invention comprises the near-field communication module connected to the passive selection circuit. Thus, the device may be a fob or a key which may receive high-frequency signals and near-field signals all while being compact and energy-efficient.

Preferably, the near-field communication module is connected to the passive selection circuit via a printed circuit track.

In a second embodiment, the device is configured to communicate with a smartphone via a communication link. The device may then assist the smartphone, for example with the high-frequency processing module which is generally not comprised in existing phones.

Advantageously, in this second embodiment, the communication link is wired or wireless.

The device may thus be connected to the phone by a cable, for example of USB type.

The device may also be connected to the phone by a wireless communication link, for example of radiofrequency wave type.

According to another aspect, the invention also relates to an assembly comprising a device as presented and a smartphone configured to communicate with said device via a communication link.

The communication link may be wired or wireless in nature.

Advantageously, in the assembly as presented, the near-field communication module is implemented in the smartphone. This scenario is the simplest to implement since the majority of existing smartphones already comprise a near-field communication module.

According to another aspect, the invention also relates to a vehicle configured to communicate in high-frequency signals or in near-field signals with a device or an assembly as presented.

According to another aspect, the invention also relates to a method of selecting frequency between a vehicle as presented and a device or an assembly as presented, said vehicle being configured to emit high-frequency signals and near-field signals, said method comprising the steps of:
receiving, via the communication antenna of the device, a radiofrequency signal,
generating, via the communication antenna of the device, a voltage across the terminals of the matching circuit,
if the voltage generated is high enough, configuring the passive selection circuit in a closed circuit,
sending, via the passive selection circuit, the signal received by the communication antenna to the near-field communication module,
if the voltage generated is too low, configuring the passive selection circuit in an open circuit,
sending the signal received by the communication antenna to the high-frequency processing module.

According to another aspect, the invention also relates to a method for determining the distance between a vehicle and a device or an assembly as presented, said vehicle being configured to emit and receive high-frequency signals and near-field signals, said method comprising the steps of:
emitting, via the vehicle, a radiofrequency signal,
receiving, via the device, the radiofrequency signal emitted,
generating, via the communication antenna of the device, a voltage across the terminals of the matching circuit,
if the voltage generated is low enough, configuring the passive selection circuit in an open circuit,
sending the signal received by the communication antenna to the high-frequency processing module,
processing, via the high-frequency processing module, the signal sent and emitting a radiofrequency signal,
receiving, via the vehicle, the radiofrequency signal sent and calculating the distance between the vehicle and the device.

Advantageously, in the method as presented, the device is configured to communicate with the vehicle over a Bluetooth® Low Energy (BLE) radiofrequency link, the vehicle is configured to calculate the distance between the vehicle and the device on the basis of the exchanges of the Bluetooth® Low Energy (BLE) signals and wherein the step of receiving, via the vehicle, the high-frequency signal sent and calculating the distance between the vehicle and the device is followed by a step of comparing the distance calculated on the basis of the exchanges of high-frequency signals with the distance calculated on the basis of the exchanges of Bluetooth® Low Energy signals, and a step of validating the measured distance if the two distances are equal.

### BRIEF DESCRIPTION OF THE DRAWINGS

Other features and advantages of the invention will become more apparent upon reading the following description. It is purely illustrative and should be read with reference to the appended drawings, in which:

FIG. 1 schematically illustrates a vehicle and an assembly comprising a device according to an aspect of the invention.

FIG. 2 schematically illustrates a first embodiment of the device according to the invention.

FIG. 3 schematically illustrates a second embodiment of the device according to the invention connected to a smartphone.

FIG. 4 illustrates the frequency selection method according to an aspect of the invention.

FIG. 5 illustrates the distance measurement confirmation method according to an aspect of the invention.

### DETAILED DESCRIPTION OF EXEMPLARY EMBODIMENTS

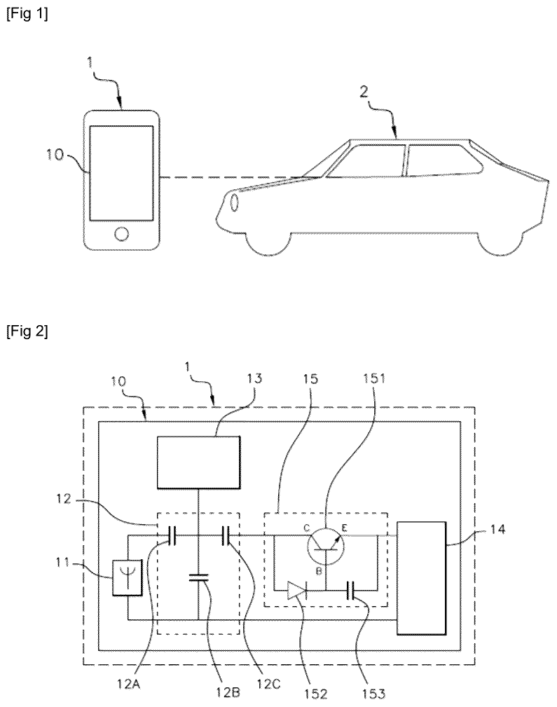

As shown in FIG. 1, the assembly 1 comprising a device 10 according to an aspect of the invention communicates with a vehicle 2.

### Assembly 1

In a first embodiment, shown in FIGS. 1 and 2, the assembly 1 comprises a communication device 10.

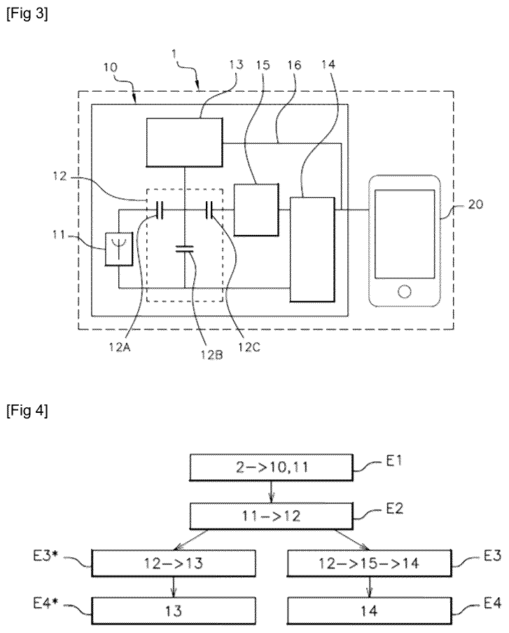

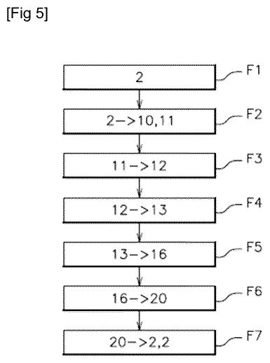

In a second embodiment, shown in FIG. 3, the assembly 1 comprises a communication device 10 and a smartphone 20.

### Communication Device 10

As shown in FIG. 2, the device 10 comprises an antenna 11, a matching circuit 12, a high-frequency processing module 13, a near-field communication module 14 and a passive selection circuit 15.

In the embodiment shown in FIG. 3, the device 10 also comprises a communication link 16. In this embodiment, the device 10 is an accessory, for example a casing or an add-on, connected to a smartphone 20 via the communication link 16.

In another embodiment, not shown in the figures, the device 10 is a smartphone 20 comprising the antenna 11, the matching circuit 12, the high-frequency processing module 13, the near-field communication module 14 and a passive selection circuit 15.

### Communication Antenna 11

The antenna 11 is an antenna configured to receive high-frequency radiofrequency signals, between 3 MHz and 30 MHz, and near-field signals, at a precise frequency of 13.56 MHz.

When the antenna 11 receives a high-frequency signal, it generates a voltage across its terminals.

### Matching Circuit 12

The matching circuit 12 is connected to the antenna 11, to the high-frequency processing module 13 and to the passive selection circuit 15.

The matching circuit 12 comprises a first capacitor 12A, a second capacitor 12B and a third capacitor 12C.

As shown in FIG. 2, the first capacitor 12A is connected to one pole of the antenna 11. The second capacitor 12B is connected to the first capacitor 12A and to the other pole of the antenna 11.

The third capacitor 12C is connected to the first capacitor 12A and to the passive selection circuit 15.

The first capacitor 12A and the second capacitor 12B are configured to form a loop circuit when the antenna 11 receives high-frequency signals from a long distance, and so that the resonant frequency of this circuit is matched to the frequency of the high-frequency signal received.

The first capacitor 12A, the second capacitor 12B and the third capacitor 12C are configured to form a loop circuit with the passive selection circuit 15 and the near-field communication module 14 when the antenna 11 receives near-field signals from a short distance, below 10 cm.

The loop circuit thus formed has a resonant frequency matched to the frequency of the received NFC signal of 13.56 MHz.

### High-Frequency Processing Module 13

The high-frequency processing module 13 is electrically connected to the matching circuit 12.

The high-frequency processing module 13 is configured to pick up the changes in voltage in the matching circuit 12 and to process these changes in order to extract therefrom the high-frequency signal received by the antenna 11 of the device 10.

The processing of the high-frequency signal is known per se.

In the embodiment shown in FIG. 3, the high-frequency processing module 13 is connected to the smartphone 20 via the communication link 16.

The high-frequency processing module 13 may transmit high-frequency signals received by the antenna 11 and processed by the device 10 to the smartphone 20.

Preferably, the communication link 16 comprises a processing module for converting the signals before sending them to the smartphone 20. The processing module is not shown in the figures for the sake of clarity.

### Near-Field Communication Module 14

In the embodiments shown in the figures, the near-field communication module 14 is integrated into the same electrical circuit as the matching circuit 12 via the passive selection circuit 15.

When the passive selection circuit 15 is closed, the near-field communication module 14 is configured to pick up the changes in voltage in the matching circuit 12 and to process these changes in order to extract therefrom the near-field signal received by the antenna 11 of the device 10.

The processing of the near-field signal is known per se.

In the embodiment shown in FIG. 3, the near-field communication module 14 is connected to the smartphone 20 via the communication link 16.

The near-field communication module 14 may transmit near-field signals received by the antenna 11 and processed by the device 10 to the smartphone 20.

Preferably, the communication link 16 comprises a processing module for converting the signals before sending them to the smartphone 20. The processing module is not shown in the figures for the sake of clarity.

### Passive Selection Circuit 15

The passive selection circuit 15 is electrically connected to the matching circuit 12 and to the near-field communication module 14.

The passive selection circuit 15 is configured to act as an open switch when the signal received by the device 10 is a high-frequency signal the source of which is a distance greater than 10 cm from the device 10 and to act as a closed switch when the signal received by the device 10 is a near-field communication signal, that is to say a signal of 13.56 MHz the source of which is a distance less than 10 cm away.

As shown in FIG. 2, the passive selection circuit 15 comprises a transistor 151, a diode 152, and a capacitor 153.

The transistor 151 is advantageously a bipolar transistor comprising a collector C, a base B and an emitter E.

The transistor 151 is configured to allow a current to flow between the collector C and the emitter E only if a sufficient current is supplied to the base B.

The collector C is connected to the matching circuit 12, the emitter E is connected to the input of the near-field communication module 14, and the base B is connected to the midpoint connecting the output terminal of the diode 152 to the capacitor 153.

The diode 152 comprises an input terminal and an output terminal. An electric current may flow through the diode 152 from its input terminal to its output terminal but the reverse is impossible.

The input terminal of the diode 152 is connected to the collector C of the transistor 151.

The output terminal of the diode 152 is connected to the base B of the transistor 151.

The diode 152 only allows the electric current to flow from its input terminal to its output terminal, ensuring that the current flows from the matching circuit 12 to the base B of the transistor 151.

The capacitor 153 is connected to the base B and to the emitter E of the transistor 151.

The capacitor 153 makes it possible to adjust the voltage at the base B of the transistor 151.

### Communication Link 16

In the embodiment shown in FIG. 3, the device 10 comprises a communication link 16 which makes it possible to communicate with a smartphone 20.

The communication link 16 may be wired, for example via a USB connection, or wireless, for example via BLE (Bluetooth® Low Energy).

The communication link 16 allows the high-frequency processing module 13 and the near-field communication module 14 to communicate directly with the smartphone 20 without passing through the antenna 11.

In the case where the communication link 16 is a wireless communication link, the device 10 may communicate directly with the vehicle 2 via the communication link 16.

In particular, if the communication link 16 is of Bluetooth® Low Energy type, the device 10 may communicate with the vehicle 2 using Bluetooth® Low Energy.

### Smartphone 20

The smartphone 20 is the smartphone of the user of the vehicle 2.

In the embodiment shown in FIG. 3, the smartphone 20 is connected to the device 10 via the communication link 16.

In this embodiment, the device 10 is an accessory of the smartphone 20, and may be comprised in an external casing in which the smartphone 20 is inserted or in an add-on connected to the smartphone 20.

The smartphone 20 may communicate with the vehicle 2 via radiofrequency signals.

### Vehicle 2

The vehicle 2 comprises means for emitting radiofrequency signals, in particular high-frequency signals and near-field communication signals.

Advantageously, the vehicle 2 also comprises at least one BLE (Bluetooth® Low Energy) emission and reception means.

### Example of Implementation

### First embodiment

As shown in FIGS. 1 and 2, the assembly 1 contains only the device 10 in the first embodiment.

In a preliminary step, the vehicle 2 emits a radiofrequency signal.

In a first step E1, the device 10 receives the radiofrequency signal emitted by the vehicle 2.

The device 10 of the assembly 1 receives the radiofrequency signal when said radiofrequency signal reaches the antenna 11 of the device 10.

In a second step E2, the antenna 11 generates an oscillating voltage according to the radiofrequency signal received.

This voltage causes electrical charges to flow across the terminals of the antenna 11.

The amplitude of the voltage generated depends on the strength of the radiofrequency signal received. This strength decreases as the distance between the vehicle 2 and the device 10 increases.

If the radiofrequency signal emitted by the vehicle 2 is of near-field communication type, the device 10 only captures this signal if it is very close to the vehicle 2, within 10 cm.

The radiofrequency signal received by the device 10 is then very strong and the amplitude of the voltage generated is high.

Consequently, the voltage at the base B of the transistor 151 of the passive selection circuit 15 is high and allows the transistor 151 to behave like a closed switch, thus causing current to flow to the near-field communication module 14 in a step E3.

In a step E4, the near-field communication module 14 receives the signal and processes it.

The capacitors 12A, 12B and 12C have capacitances matched to the expected frequency of the near-field communication signal of 13.56 MHz. The matching circuit 12 thus makes it possible to adapt, in one step, the voltage oscillation into a signal usable by the near-field communication module 14.

If the radiofrequency signal emitted by the vehicle 2 is of high-frequency communication type, the device 10 may capture this signal at a greater distance from the vehicle 2, of the order of a few meters.

The radiofrequency signal received by the device 10 is then not as strong and the amplitude of the voltage generated is not as high.

Consequently, the voltage at the base B of the transistor 151 of the passive selection circuit 15 is no longer sufficient and the transistor 151 behaves like an open switch, preventing the current from reaching the near-field communication module 14.

The capacitor 12C of the matching circuit 12 is no longer supplied with power and the signal is then captured by the high-frequency processing module 13 in a step E3*.

In a step E4*, the high-frequency processing module 13 receives the signal and processes it.

The matching circuit 12, with the capacitors 12A, 12B, thus makes it possible to adapt, in one step, the voltage oscillation into a signal usable by the high-frequency processing module 13.

### Second Embodiment

In the second embodiment, shown in FIG. 3, in which the device 10 is an accessory connected to a smartphone 20 via the communication link 16, the method proceeds in an identical manner.

This embodiment is thus advantageous for smartphones 20 which do not comprise a high-frequency processing module 13.

This embodiment thus allows the assembly 1 to implement a method for determining the distance between the vehicle 2 and the assembly 1 comprising the device 10 and a smartphone 20.

In a step F1, the vehicle 2 emits high-frequency signals.

In a step F2, the device 10 receives the high-frequency signals sent by the vehicle 2.

Due to the high frequency, the voltage that these signals received by the antenna 11 generates is not sufficient for the passive selection circuit 15 to close; the high-frequency signals are therefore transmitted to the high-frequency processing module 13 via the matching circuit 12 in a step F3.

The high-frequency processing module 13 receives the signals sent by the vehicle 2 in a step F4 and detects that the user carrying the assembly 1 is located in a nearby area around the vehicle 2.

In a step F5, the high-frequency processing module 13 generates a response signal which is sent to the smartphone 20 via the communication link 16 and which is then sent to the vehicle 2 via the smartphone 20 in a step F6.

As a variant, when the communication link 16 is a wireless link, in particular a Bluetooth® Low Energy link, the device 10 may send the signal to the vehicle 2 directly via the wireless communication link 16.

The signal sent to the vehicle 2 via the smartphone 20 is preferably a Bluetooth® Low Energy signal.

In a step F7, the vehicle 2 receives the response signal and calculates the distance between the vehicle 2 and the user carrying the assembly 1.

The distance may be calculated on the basis of the RSSI (Received Signal Strength Indicator), that is to say the strength of the signal received in the case of Bluetooth® Low Energy signals, or by measuring the amplitude of the signal received for high-frequency signals.

This distance calculation may be used to activate approach functions of the vehicle 2, such as, for example, unlocking the opening elements or else switching on the air conditioning, when the user approaches close enough to the vehicle 2.

This method of determining distance via high-frequency signals makes it possible to limit the risks associated with the positioning of the smartphone 20 in relation to the user, which may cause a disturbance of the signals due to organic tissues or metal elements.

This method of determining distance via high-frequency signals may be carried out in addition to a distance determination method carried out by the smartphone 20 itself via Bluetooth® Low Energy signals in order to confirm the determined distance.

Specifically, Bluetooth® Low Energy signals are more likely to be disturbed by human tissues and metal elements, this possibly distorting the distance measurement if the smartphone 20 is carried, for example, in a rear pocket of the user's trousers or else close to metal elements such as keys.

The antenna 11 of the device 10 may also capture near-field signals when the user is close enough to the vehicle 2 and ensure redundancy with the antenna of the smartphone 20 in the case where the near-field signals are blocked by a part of the user's body or else by metal elements.

1. A communication device for a motor vehicle, said device comprising a single communication antenna, a matching circuit configured to match the impedance of said communication antenna, a high-frequency processing module connected to said matching circuit and configured to process high-frequency signals received by the antenna, and a passive selection circuit connected to the matching circuit and configured to communicate with a near-field communication module so that said near-field communication module receives signals via the antenna, the communication device being configured such that, when it receives, via the antenna, high-frequency signals having a strength below a predetermined strength threshold, the passive selection circuit operates in an open circuit, and, when it receives, via the antenna, near-field signals having a strength above the predetermined strength threshold, the passive selection circuit operates in a closed circuit and transfers said signals, via the matching circuit, to the near-field communication module.

2. The device as claimed in claim 1, in which the passive selection circuit comprises a transistor, said transistor comprising a collector, a base and an emitter, said collector being connected to the output of the matching circuit, said emitter being configured to communicate with the near-field communication module, said base being connected to said collector.

3. The device as claimed in claim 1, in which the matching circuit comprises a plurality of at least three electrical capacitors, including a first capacitor connected in series with one pole of the antenna, the second capacitor and the third capacitor being connected to the first capacitor, the second capacitor being connected to the passive selection circuit, the third capacitor being connected to another pole of the antenna, and the high-frequency processing module being connected to the junction between the three capacitors.

4. The device as claimed in claim 1, said device comprising the near-field communication module connected to the passive selection circuit.

5. The device as claimed in claim 4, said device being configured to communicate with a smartphone via a communication link.

6. The device as claimed in the preceding claim 5, in which the communication link is wired or wireless.

7. An assembly comprising a device as claimed in claim 1 and a smartphone configured to communicate with said device via a communication link.

8. The assembly as claimed in claim 7, in which the near-field communication module is implemented in the smartphone.

9. A vehicle configured to communicate in high-frequency signals or in near-field signals with a device as claimed in claim 1.

10. A method of selecting signals between a vehicle and a communication device as claimed in claim 1, an emitter being configured to emit high-frequency signals and near-field signals, said method comprising the steps of:
receiving, via the antenna of the device, a radiofrequency signal,
generating, via the antenna of the device, a voltage across the terminals of the matching circuit,
if the voltage generated is high enough, configuring the passive selection circuit in a closed circuit,
sending, via the passive selection circuit and the matching circuit, the signal received by the antenna to the near-field communication module,
if the voltage generated is too low, configuring the passive selection circuit in an open circuit,
sending, via the matching circuit, the signal received by the antenna to the high-frequency processing module.

11. A vehicle configured to communicate in high-frequency signals or in near-field signals with an assembly as claimed in claim 7.
